(19) United States
(12) Patent Application Publication
(10) Pub. No.: US 2026/0318026 A1
(43) Pub. Date: Oct. 15, 2026

(54) Cleaning Vehicle for Cleaning Track Rails

(71) Applicant: Glatt Gesellschaft mit beschrankter Haftung, Binzen (DE)

(72) Inventors: Eckhardt Krebs, Witterda (DE); Michael Grimann, Kassel (DE); Reinhard Nowak, Lörrach (DE)

(21) Appl. No.: 19/476,264

(22) PCT Filed: Feb. 28, 2024
(86) PCT No.: PCT/EP2024/055084

§ 371 Date: Oct. 17, 2025

(30) Foreign Application Priority Data
Apr. 20, 2023 (DE) 10 2023 110 077.7

(51) Int. Cl. E01H 8/10; B08B 7/00

(52) U.S. Cl. CPC E01H 8/10; B08B 7/0042

(57) ABSTRACT

A cleaning vehicle with which the two rails of a track for rail vehicles can be cleaned by removing contaminants. The cleaning vehicle includes several track wheels with which it can move along a track to perform a cleaning run during which the laser radiation from an on-board laser cleaning device can be used to perform a surface treatment of the track rails that induces the removal of contaminants. The laser cleaning device has a plurality of cleaning units, each assigned to a rail to be cleaned, which include a laser radiation exit area at which the laser radiation that can be generated by a laser of the laser cleaning device can exit.

### CROSS-REFERENCE TO RELATED APPLICATIONS

This application is the United States national phase of International Patent Application No. PCT/EP2024/055084 filed Feb. 28, 2024, and claims priority to German Patent Application No. 10 2023 110 077.7 filed Apr. 20, 2023, the disclosures of which are hereby incorporated by reference in their entireties.

### BACKGROUND

### Field

The invention relates to a cleaning vehicle for cleaning the two rails of a track for rail vehicles,
having a plurality of track wheels, via which the cleaning vehicle can be placed in a position of use on the two rails of a track, wherein the cleaning vehicle in its position of use can perform a vehicle movement on the two rails along the track, which can be induced by an associated drive device,
and having a rail cleaning device which comprises a cleaning unit for each of the two rails of a track to be cleaned, which can be positioned or is positioned in the vicinity of the rail to be cleaned at least during a cleaning run of the cleaning vehicle that is performed by the vehicle movement, in order to perform a surface treatment on this rail during a cleaning process, which treatment induces the removal of contaminants.

### Description of Related Art

Depending on usage and environmental influences, the rails of tracks for rail vehicles may comprise contaminants that result in increased slippage during the transmission of driving force between the driven track wheels of rail vehicles and the rails of the track, which can lead to wear on both the track wheels and the rails. To improve the coefficient of friction and reduce slippage, some railway traction vehicles are equipped with automatic sanding devices, but their use usually results in even greater wear. To counteract this problem, the rails in the affected areas have been cleaned chemically or using abrasive technologies. However, chemical cleaning has the disadvantage of contaminating the ballast bed and track ground, which is particularly problematic in the case of repeated cleaning. According to the applicant's internal knowledge, abrasive cleaning is carried out, for example, using rail vehicles equipped with cleaning units in the form of rotating grinding attachments or wire brushes to achieve mechanical removal of contaminants. However, this abrasive cleaning method does not sufficiently remove residues such as grease or oil, and there is a risk that repeated cleaning will impair the rail geometry.

A cleaning vehicle designed in accordance with the characteristics mentioned at the beginning is described, for example, in the AMT Group's company information ‘Track Construction Trailer 20T’, page 10, and can be placed on a track in a position of use in order to perform a cleaning run along the track, which can be initiated by an assigned drive device. The cleaning vehicle is equipped with a rail cleaning device with which a water spray treatment of the rails can be carried out to remove contaminants.

### SUMMARY

The invention is based on the problem of providing a cleaning vehicle for rail cleaning, with which contaminants, including corrosion, can be removed from rails effectively and in a time-saving manner without changing the rail geometry or other mechanical characteristics of the rails.

To solve this problem, the invention provides that, in a cleaning vehicle in connection with the features mentioned above, the rail cleaning device is designed as a laser cleaning device comprising a laser located on board the cleaning vehicle, wherein each cleaning unit comprises a laser radiation exit area for the exit of laser radiation which can be generated by the laser and directed onto the rail to be cleaned in order to remove contaminants.

The cleaning vehicle according to the invention enables mobile laser radiation cleaning of rails, which is characterised by time-saving application, high effectiveness and gentle treatment of the rails.

Like a conventional rail vehicle, the cleaning vehicle comprises a suitable number of track wheels, which allow it to be placed in a position of use on the two rails of a track in order to thoroughly remove, during a cleaning run using laser technology, any contaminants adhering to the rails or other contaminants such as dirt, oil, grease or corrosion adhering to the rails using laser radiation. Existing contaminants such as layers of dirt and corrosion can be gently removed by evaporation without the need for mechanical abrasives such as sand or glass or additional cleaning agents. The cleaning process is therefore environmentally friendly and cost-effective. The intensity of the surface treatment can be individually adjusted depending on the rail material by selecting a suitable radiation energy and/or laser radiation shape in order to achieve the best possible cleaning result. Laser irradiation can be pulsed or continuous, to be performed in particular depending on the degree of contamination and the speed of the cleaning vehicle. The laser cleaning device has a laser on board the cleaning vehicle, which consequently always moves directly with the vehicle movement of the cleaning vehicle, so that no additional logistical measures are required to provide the laser. A cleaning unit is provided for each rail to be cleaned, which comprises a laser radiation exit area for laser radiation that can be generated by the laser and is arranged in such a way that the exiting laser radiation hits the rail to be cleaned at a desired angle. Several cleaning units, arranged one behind the other in the direction of travel, can also be provided for each rail to be cleaned. Since the laser treatment is very gentle on the material despite its high effectiveness, there is a high potential for savings in maintenance costs for rails and the rail vehicles that normally travel on the tracks compared to conventional cleaning methods. Since the laser operates without media, contamination of the track environment by cleaning agents can also be avoided.

Advantageous further developments of the invention are apparent from the dependent claims.

In principle, the two cleaning units can be combined in a single assembly. However, it is considered more advantageous if the cleaning units are arranged at a distance from each other transversely to the direction of travel of the cleaning vehicle. This facilitates individual alignment where necessary.

The cleaning vehicle is expediently equipped with a seat that can be used by the operating personnel on board the cleaning vehicle during vehicle movement. The seat includes at least one vehicle seat. The seat allows for fatigue-free cleaning work over a very long period of time.

Lasers are generally classified into different laser classes based on their potential hazard. Class 1 lasers pose the lowest potential hazard. Class 4 lasers are extremely dangerous due to their high intensity, making the available laser radiation extremely hazardous. However, a laser belonging to class 4 in terms of intensity is recommended for effective rail cleaning. To ensure that such a class 4 laser can also be used without restriction in heavily frequented areas, it is advantageous if the laser cleaning device is equipped with a class 4 laser, but each cleaning unit comprises a laser radiation shielding device to shield the laser radiation, which means that the laser cleaning device as a whole can only be classified as the unproblematic laser class 1.

It is considered advantageous if each cleaning unit comprises a laser radiation shielding device with a shielding housing that encloses a working chamber in an opaque manner, i.e. without any possibility of laser radiation escaping, wherein the laser radiation exit area is located inside the working chamber. To enable cleaning measures, the shielding housing comprises a window that facing or being able to face the rail to be cleaned during a cleaning process, through which the laser radiation emitted within the working chamber at the laser radiation exit area can irradiate the associated rail without damaging the immediate or wider environments.

Preferably, each cleaning unit has a radiation output head comprising a laser radiation exit area, wherein a laser optic is assigned to the laser radiation exit area. The laser optic may have lenses and/or mirrors to configure the laser radiation as required.

Each radiation output head is preferably located inside the working chamber of the associated cleaning unit.

It is advantageous if each cleaning unit is assigned a positioning device to enable positioning at different height positions. For example, the positioning device can be designed to move the cleaning unit in question either to at least one lowered operation position for performing laser cleaning processes or to at least one raised standby position for vehicle movements other than during cleaning runs.

Preferably, the laser cleaning device is additionally equipped with a suction device for removing ablation media produced during the cleaning process in the area of the cleaning units. Since the ablation media are predominantly gaseous in consistency, suction cleaning can effectively prevent contamination of the surroundings.

The suction device is designed in particular so that the ablation media can be extracted in the immediate vicinity of their origin. For this purpose, the suction device expediently comprises at least one suction opening in the area of each cleaning unit, which communicates with a suction power unit of the suction device. If the cleaning units comprise a laser radiation shielding device, it is advisable for the suction opening to be located inside the working chamber of the associated cleaning unit. In principle, however, the suction opening can also be located outside a cleaning unit, in particular behind the cleaning unit in the opposite direction to the direction of travel of the cleaning vehicle.

The drive device designed to induce the vehicle movement and, accordingly, the cleaning run is expediently a direct part of the cleaning vehicle. The cleaning vehicle is thus a ‘self-propelled’ vehicle, which makes it unnecessary to resort to an additional towing or pushing vehicle. The drive device is connected to one or more of the track wheels for propulsion, thus enabling the cleaning vehicle to be propelled directly along a track. The drive device can be used both for cleaning runs and for movement runs without an active rail cleaning device to cover distances between track sections to be cleaned.

In principle, the cleaning vehicle can be designed without its own drive system and comprise at least one coupling device, which allows the preferably detachable coupling of a drive vehicle comprising the drive device.

The drive device is preferably an electric drive device which obtains its drive energy, for example, from an on-board accumulator and/or via a current collector system from a current-carrying conductor system laid along the track.

The electrical energy required to operate the laser cleaning device is expediently supplied by a power generator located on board the cleaning vehicle. Such a power generator expediently comprises a combustion engine as its drive source, so that, in particular, rail cleaning of non-electrified track sections is also possible without any problems.

In principle, the electrical energy required to operate the laser cleaning device can also or alternatively be provided by an electricity storage device or accumulator. For use on electrified tracks, the cleaning vehicle can be equipped with a current collector system.

The same power generator can, for example, be designed to generate electrical energy for both the drive device and the laser cleaning device.

The track wheels are expediently equipped with at least one wheel flange each, which provides transverse support on a rail for guidance during vehicle movement. The wheel flange technology can correspond to that of conventional rail vehicles.

In addition to the track wheels, the cleaning vehicle may comprise conventional wheels that enable it to move without rails on normal ground such as roads or other terrain. These additional wheels preferably have pneumatic-tired wheels. The wheels allow the cleaning vehicle to be easily moved between different locations independently of track structures. Expediently, the cleaning vehicle is equipped in such a way that either the track wheels or the wheels can be used to move the cleaning vehicle, while the other wheels are temporarily in a deactivated standby position.

The cleaning vehicle expediently has a vehicle chassis on which the track wheels are arranged. The vehicle chassis is, for example, frame-like and/or panel-shaped. The cleaning units are preferably arranged on the vehicle chassis, in particular in a height-adjustable manner, so that the working distance between the laser radiation exit area and the rail to be cleaned can be variably adjusted. In particular, the height adjustability can also be performed in such a way that the cleaning units can be moved to a raised or swivelled standby position when not in use.

It is considered advantageous if not only the track wheels but also the optional wheels are arranged on the vehicle chassis. The arrangement is designed in particular so that the track wheels and the wheels can be adjusted relative to each other in height in order to optionally position the track wheels or the wheels in a lowered, activated position in which they can be used to propel the cleaning vehicle.

In a preferred embodiment, the cleaning vehicle comprises two individual vehicles that are coupled to each other in a push-pull configuration and each have their own track wheels for placement on a track. For better differentiation, these two vehicles are referred to as the main vehicle and the auxiliary vehicle. The main vehicle contains the cleaning units, while the auxiliary vehicle contains the laser. Flexible optical connecting lines enable the transmission of the generated laser radiation between the laser and the cleaning units. This vehicle design allows for quick conversion between different lasers as needed, for example, to equip the vehicle with lasers of different power or to save time during maintenance work. For example, several auxiliary vehicles equipped with a laser can be provided, which can be alternatively coupled to one and the same main vehicle.

Expediently, the main vehicle comprises a drive device serving to propel the vehicle. The main vehicle expediently functions as a towing vehicle for an auxiliary vehicle coupled to the main vehicle as a trailer.

If the cleaning vehicle is equipped with a suction device, the suction openings are expediently located on the main vehicle and a suction power unit responsible for generating the suction flow is located on the auxiliary vehicle. Flexible suction pipes, which allow for damage-free cornering, ensure a flow connection between the suction power unit and the suction openings in order to enable a suction flow.

The optional power generator for generating the laser's operating energy is located on board the auxiliary vehicle.

In another cost-effective design, the cleaning vehicle consists of a single vehicle which comprises all the components required for the operation of the laser cleaning device. This design allows for a particularly compact cleaning vehicle and facilitates transport between different locations using a separate transport vehicle.

There is also the advantageous option of designing the cleaning vehicle as a so-called standard railway vehicle. Standard vehicles are certain rail vehicles used by German railways, including railway traction vehicles, passenger carriages and freight wagons. This design can be implemented, for example, by installing the laser cleaning device and all other components intended for the cleaning vehicle directly into a standard railway vehicle. It is considered particularly advantageous if the cleaning vehicle is a railway traction vehicle, such as a locomotive. Such embodiments enable cleaning processes to be performed during normal railway traffic and can therefore be performed in a time-and cost-saving manner without interrupting railway traffic and without temporarily closing sections of track.

### BRIEF DESCRIPTION OF THE DRAWINGS

The terms Fig., Figs., Figure, and Figures are used interchangeably in the specification to refer to the corresponding figures in the drawings.

The invention is explained in more detail below with reference to the accompanying drawing. This shows:

FIG. 1 schematic illustration of a top view of a preferred embodiment of the cleaning vehicle according to the invention in a position of use placed on a track, wherein, for the sake of clarity, the railway sleepers of the track and the track bed are not shown,

FIG. 2 a side view of the embodiment from FIG. 1 with the viewing direction according to arrow II from FIG. 1, wherein a detailed section framed by a dotted line is additionally enlarged to illustrate the structure of a preferred cleaning unit, and

FIG. 3 another embodiment of the cleaning vehicle according to the invention in a schematic illustration in a side view analogous to FIG. 2, wherein a possible embodiment as a railway traction vehicle is also illustrated in dotted lines.

Unless otherwise specified in individual cases, the following descriptions refer to all embodiments of the invention.

### DETAILED DESCRIPTION

The drawing shows a cleaning vehicle according to the invention, designated by reference numeral 1, in various advantageous equipment variants.

The cleaning vehicle 1 is used for mobile laser radiation cleaning of the two rails designated as rails 2 of a track 3, which is used for the movement of any rail vehicles and whose main application is in the field of railways, which in this case also includes city trains, trams, underground trains, etc.

Track 3 extends in a longitudinal direction 4 indicated by a dotted line and has two parallel rails 2 spaced apart from each other transversely to the longitudinal direction 4 of the track.

The rails 2 are fastened in a manner known per se to railway sleepers 6, which are fixed in a track bed 7 consisting, for example, of ballast.

In conventional use of track 3, a non-illustrated rail vehicle can support itself vertically on the two rails 2 with track vehicle wheels, wherein the track vehicle wheels can roll on the respective associated rail 2 when the rail vehicle is moving.

Cleaning vehicle 1 comprises a vehicle longitudinal axis 8 parallel to the longitudinal direction 4 of the track in its position of use, a vehicle transverse axis 11 that is orthogonal to this and courses in the direction of the spacing between the two rails 2, and a vertical vehicle high axis 12 that is orthogonal to the vehicle longitudinal axis 8 and the vehicle transverse axis 11.

The cleaning vehicle 1 can perform a vehicle movement 13 illustrated by an arrow along the track 3. During this vehicle movement 13, it rolls on the rail 2 with track wheels 14. The vehicle movement 13 is possible both forwards and backwards.

The cleaning vehicle 1 has at least two pairs of track wheels 14, wherein track wheels 14 belonging to the same pair of track wheels are opposite each other in the axial direction of the vehicle transverse axis 11. In the position of use of the cleaning vehicle 1, each track wheel 14 rests on one of the rails 2. The cleaning vehicle 1 is supported on each rail 2 by at least two track wheels 14 spaced apart in the axial direction of the vehicle longitudinal axis 8, which can roll off the rails 2.

The cleaning vehicle 1 has an expediently single-piece or multi-piece vehicle chassis 15, on which the track wheels 14 are rotatably arranged by means of suitable suspension measures.

The vehicle movement 13 can be caused by a drive device 16. In all illustrated embodiments, the drive device 16 is a direct part of the cleaning vehicle 1. For example, it is attached to the vehicle chassis 15. The drive device 16 is connected to at least one and, in particular, to several of the track wheels 14 via at least one drive train 17. The at least one drive train 17 can transfer a drive torque generated by the drive device 16 to the associated track wheel 14, which acts as a drive wheel, in order to generate the vehicle movement 13.

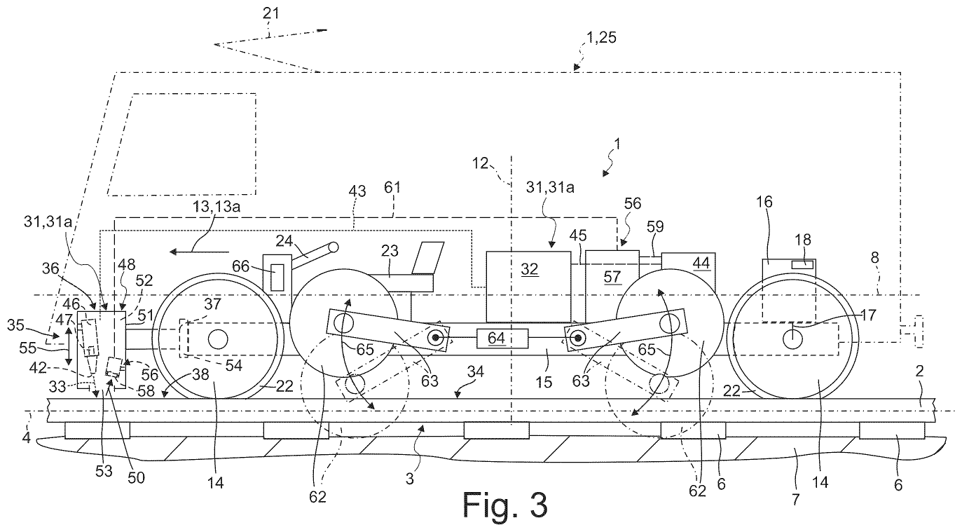

The drive device 16 is preferably an electric drive device which obtains its drive energy from an on-board accumulator 18 and/or, via a current collector system 21 indicated only in FIG. 3, from a current-carrying conductor system laid along the track 3, for example an catanary.

To ensure that cleaning vehicle 1 remains safely on track during vehicle movement 13, the track wheels 14 are expediently equipped with a wheel flange 22, which can rest against one of the two lateral rail flanks 2a, 2b of the associated rail for transverse support. The cleaning vehicle 1 is thus guided safely through the track 3 during vehicle movement 13.

Expediently, the cleaning vehicle 1 comprises at least one seat 23, for example in the form of a vehicle seat, which enables an operator of the cleaning vehicle 1 to sit down while operating the cleaning vehicle 1.

An operating device 24 located in the seating area 23 can be operated by the operating personnel as required to command the vehicle movement 13 or the standstill of the cleaning vehicle 1. The operating device 24 allows access to the drive device 16 for control purposes.

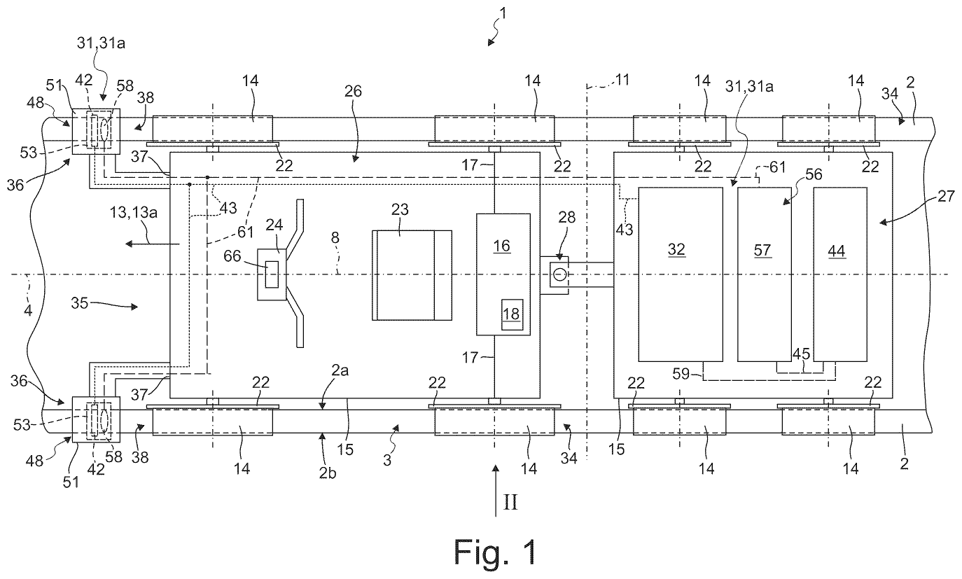

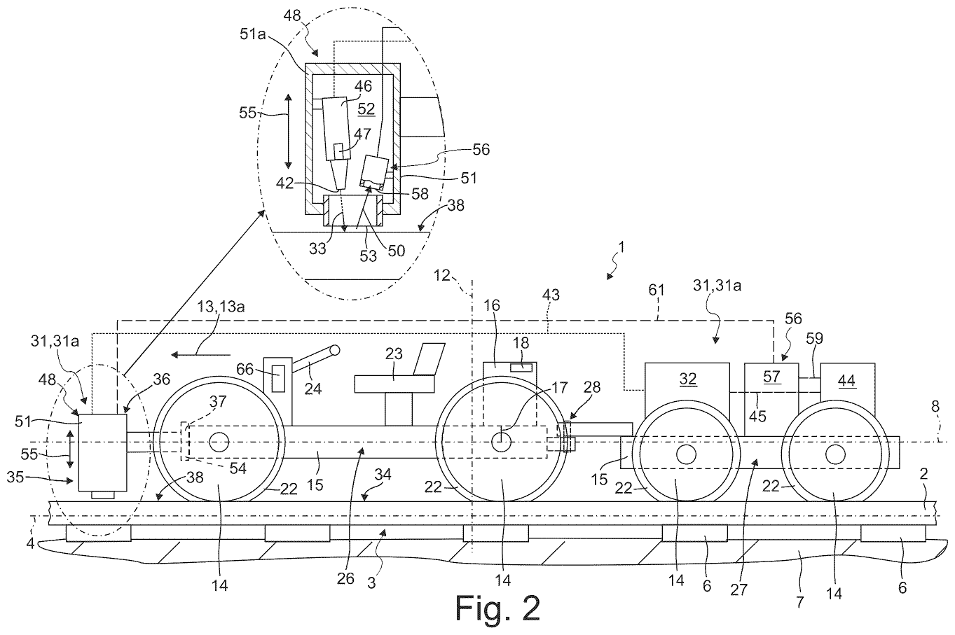

The cleaning vehicle 1 illustrated in FIGS. 1 and 2 and shown in solid lines in FIG. 3 is specially designed for the laser cleaning of the rails 2, which will be explained later, and serves no other purpose. However, there is the possibility, indicated by dotted lines in FIG. 3, of designing the cleaning vehicle 1 at the same time as a railway traction vehicle 25 or as another so-called standard railway vehicle. In this case, there is a rail vehicle with a dual function as a railway traction vehicle 25 and, at the same time, a cleaning vehicle 1, which can be used both for regular railway operations and, in particular, for cleaning rails 2. For example, a rail cleaning process can be conducted during a train journey used for passenger and/or freight transport.

According to an embodiment shown in FIGS. 1 and 2, the cleaning vehicle 1 comprises several, in particular two, vehicles 26, 27, which are coupled to each other via a mechanical coupling device 28 and are referred to as the main vehicle 26 and the auxiliary vehicle 27 for better differentiation. The coupling device 28 is designed in particular for a detachable coupling so that the two vehicles 26, 27 can be separated from each other if necessary.

The coupling device 28 connects the two vehicles 26, 27 in a manner that is resistant to push and pull forces and at the same time articulated. Preferably, the main vehicle 26 is performed as a towing vehicle and the auxiliary vehicle 27 as a trailer of the main vehicle 26. During vehicle movement 13, the main vehicle 26 travels ahead and pulls the auxiliary vehicle 27 behind it. The drive device 16 and the at least one track wheel 14 acting as a drive wheel are preferably parts of the main vehicle 26.

Both the main vehicle 26 and the auxiliary vehicle 27 comprise their own track wheels 14. For example, each of the two vehicles 26, 27 comprise two pairs of track wheels 14 arranged consecutively in the axial direction of the vehicle longitudinal axis 8.

According to the embodiments illustrated in FIG. 3, the cleaning vehicle 1 may consist of a single vehicle, whether it be a cleaning vehicle 1 used solely for cleaning purposes or a cleaning vehicle 1 that also functions as a railway traction vehicle 25.

The cleaning vehicle 1 comprises a rail cleaning device, designated by reference number 31, which is designed as a laser cleaning device 31a. The terms ‘rail cleaning device 31’ and ‘laser cleaning device 31a’ therefore refer to one and the same device. The laser cleaning device 31a is designed to treat the surface 34 of the rails 2 with the aid of laser radiation 33 generated by a laser 32 in order to remove contaminants. Due to the laser radiation treatment, this involves in particular the thermal removal of contaminants, specifically in that the contaminants are vaporised by the energy of the laser radiation 33.

Laser radiation cleaning takes place during a vehicle movement 13 of the cleaning vehicle 1 referred to as cleaning run 13a. During cleaning run 13a, the cleaning vehicle 1 moves forward, in particular with the front of the vehicle 35 leading. However, cleaning run 13a can also be carried out expediently within a backwards run.

The laser cleaning device 31 contains the aforementioned laser 32, which is located on board the cleaning vehicle 1 and is suitably attached on or to the vehicle chassis 15. Preferably, the laser 32 is attached behind the seat 23 in relation to forward travel, opposite to the direction of travel.

In the two-part embodiment of the cleaning vehicle 1 according to FIGS. 1 and 2, the laser 32 is expediently located on board the auxiliary vehicle 27.

The laser cleaning device 31a comprises two cleaning units 36, which, in the position of use of the cleaning vehicle 1, can be positioned or are positioned in the area of one of the two rails 2 to be cleaned.

The two cleaning units 36 are arranged, for example, in the area of the front of the vehicle 35 of the cleaning vehicle 1, wherein they are expediently attached to the vehicle chassis 15 via a suitable interface device 37.

The two cleaning units 36 are expediently spaced apart from each other in the axial direction of the vehicle transverse axis 11, wherein they are located at the same height in the axial direction of the vehicle longitudinal axis 8. The mutual distance between the two cleaning units 36 preferably corresponds at least substantially to the mutual distance between the two rails 2 to be cleaned. Preferably, the mutual distance between the two cleaning units 36 is variably adjustable.

The arrangement of the operational cleaning units 36 is specifically designed so that each cleaning unit 36 is positioned in the position of use of the cleaning vehicle 1 in the axial direction of the vehicle high axis 12 above one of the two rails 2. The surface 34 of each rail 2 has an up-ward-facing rail surface, hereinafter referred to as the rolling surface 38, on which the track wheels 14 roll during the vehicle movement 13 and which is vertically opposite one of the two cleaning units 36 at a height distance.

The arrangement and alignment of the cleaning units 36 described above applies accordingly to a laser radiation exit area 42 of a respective cleaning unit 36. The laser radiation exit area 42 allows the laser radiation 33 that can be generated or is generated by the laser 32 to exit and, in an operation position of the cleaning unit 36 in question that can be seen in all the figures, is aligned in such a way that it faces the rail 2 to be cleaned and, in particular, its rolling surface 38.

The laser radiation exit area 42 is optically connected to the laser 32 via at least one optical connecting line 43, which is only schematically indicated. The laser radiation generated by the laser 32 can obtain through the optical connecting line 43 to the laser radiation exit area 42 and exit there for energetic irradiation of the associated rail 2.

In the embodiment with a two-part cleaning vehicle 1 according to FIGS. 1 and 2, the cleaning units 36 are arranged on the main vehicle 26, wherein the at least one optical connecting line 43 preferably comprises flexible properties so that it is not damaged when cornering due to the cleaning vehicle 1 bending in the area of the coupling device 28. It is understood that the optical connecting line 43 may also comprise flexible properties in a cleaning vehicle 1 consisting of only a single vehicle, as shown in FIG. 3.

In order to provide the electrical energy required to operate the laser 32, the laser cleaning device 31a is expediently equipped with a power generator 44. The power generator 44 is, for example, a diesel generator. The power generator 44 is located on board the cleaning vehicle 1 so that it always follows its vehicle movement 13.

In a cleaning vehicle 1 comprising a main vehicle 26 and an auxiliary vehicle 27, the power generator 44 is expediently a part of the auxiliary vehicle 27, which applies to the embodiment shown in FIGS. 1 and 2. The power generator 44 is expediently located independently of the vehicle body near the laser 32 so that the power supply lines 45 can be as short as possible.

In a non-illustrated embodiment, the laser 32 is powered from the same power source as the drive device 16, for example via an accumulator or via a current collector system 21, as illustrated in the embodiments of FIG. 3 in connection with the railway traction vehicle 25.

The laser cleaning device 31a comprises, expediently for each cleaning unit 36, a radiation output head 46 designed as part of the relevant cleaning unit 36, on which the laser radiation exit area 42 is located. The radiation output head 46 is preferably equipped with a laser optic 47, which is responsible for the radiation geometry of the laser radiation to exit 33 and ensures, for example, that the laser radiation hits the surface to be cleaned 34 in a point-shaped or line-shaped manner.

Preferably, the laser optic 47 is designed or adjustable in such a way that the laser radiation 33 hits the entire width of the rolling surface 38, so that the laser cleaning process can take place without periodic transverse movements of the laser radiation 33 in the axial direction of the vehicle transverse axis 11.

Preferably, each of the two cleaning units 36 is equipped with a laser radiation shielding device 48, which in particular prevents hazardous to health laser radiation 33 from exiting in a manner that could endanger people.

For example, the laser radiation shielding device 48 contains a shielding housing 51, which is clearly visible in the enlarged sectional view of FIG. 2 and comprises an opaque housing wall 51a. The shielding housing 51 encloses a housing chamber designated as a working chamber 52, in which the laser radiation exit area 42 is located. For example and preferably, the entire radiation output head 46 is accommodated in the working chamber 52, wherein it is expediently attached directly or indirectly to the housing wall 51a.

The housing wall 51a encloses the working chamber 52, in particular on an upper side oriented in the axial direction of the vehicle high axis 12 and also around the sides. On a lower side facing a rail 2 in the position of use of the cleaning vehicle 1, the shielding housing 51 has a window 53 framed by the housing wall 51a, through which the laser radiation 33 exiting within the working chamber 52 at the laser radiation exit area 42 can exit from the shielding housing 51 in accordance with the arrow shown in the drawing in order to irradiate the adjacent rail 2.

At least during a cleaning run 13a, the window 53 is positioned very close to the rail 2, i.e. with a very small height clearance to the rolling surface 38, so that reflective laser radiation is reflected back into the working chamber 52 at least to a large extent and is not emitted into the surroundings of the cleaning unit 36.

In particular, to enable the setting of an optimized low height distance between the cleaning unit 36 and the rail 2 to be cleaned, each cleaning unit 36 can be designed to be height-adjustable. For example, each cleaning unit 36 is attached to the vehicle chassis 15 via a positioning device 54, which is only shown schematically, in such a way that it can be adjusted relative to the vehicle chassis 15 in the axial direction of the vehicle high axis 12 by performing a height adjustment movement 55 indicated by a double arrow, and can be positioned at different height positions. The positioning device 54 is, for example, a part of the interface device 37 or forms this interface device 37.

The positioning device 54 can also be designed in such a way that the associated cleaning unit 36 can be positioned either in an operation position corresponding to the arrangement described above or in a standby position away from the operation position. In the standby position, the distance to the rails 2 is greater than in the operation position. Expediently, each cleaning unit 36 is moved to the standby position at times other than during cleaning runs and, for example, when manoeuvring the cleaning vehicle 1, in order to prevent damage.

Preferably, the laser cleaning device 31a is equipped with a laser 32 that falls into laser class 4. However, due to the described encapsulation of the laser radiation exit area 42 by means of a laser radiation shielding device 48, laser class 1 is achieved in terms of operational readiness. In this way, cleaning measures can be performed with high laser energy and correspondingly high thoroughness without having to take into account the fact that cleaning runs are also performed in public or in heavily frequented areas, for example.

In order to prevent or minimise contamination-related damage to the surroundings, it is advantageous if the laser cleaning device 31a is equipped with a suction device 56, as shown in all of the illustrated embodiments, which enables the suction cleaning of ablation media that are produced during a cleaning process in the area of the cleaning units by the laser treatment.

The suction device 56 includes, for example, a suction power unit 57 located on board the cleaning vehicle 1, wherein in a cleaning vehicle 1 comprising a main vehicle 26 and an auxiliary vehicle 27, it is expediently designed as a part of the auxiliary vehicle 27. The latter is the case in the illustrated embodiment of FIGS. 1 and 2.

The suction power unit 57 is expediently equipped with a filtering device in a manner known per se and has at least one receiving space in which suctioned particles are collected for later disposal.

The suction device 56 comprises several suction openings 58, at least one of which is arranged in the area of each cleaning unit 36. Each suction opening 56 is connected to the suction power unit 57 via a suction pipe 61, which is only shown schematically, so that during operation of the suction device 56, a suction flow can be formed between the area of the suction opening 58 and the suction power unit 57. The suction process taking place in the area of the rails 2 is indicated by an arrow at 50.

The suction pipe 61 has expediently flexible properties and is implemented, for example, by means of one or more suction hoses.

Preferably, the suction opening 58 assigned to a respective cleaning unit 36 is arranged inside the working chamber 52 of the laser radiation shielding device 48. The resulting ablation media, which are predominantly gaseous in nature, can thus be extracted extremely effectively in the immediate vicinity of the point of origin, as indicated by arrow 50.

In a non-illustrated embodiment, the suction openings 58 are located outside the working chamber 52, but preferably in the immediate vicinity of the cleaning units 36 and, expediently, in an area downstream of the cleaning units 36 in the opposite direction to the direction of travel of the cleaning run 13a.

The suction device 56 is designed to be electrically operated. The power generator 44 described above also serves expediently to supply power to the suction device 56. For example, it is connected to the electrically operated suction power unit 57 via additional power supply lines 59.

In accordance with the embodiment illustrated by solid lines in FIG. 3, the cleaning vehicle 1 may comprise, in addition to the track wheels 14, a plurality of wheels 62 which allow the cleaning vehicle 1 to move without rails and without the involvement of the track wheels 14. In this way, the cleaning vehicle 1 can be moved between different locations independently of tracks, for example by travelling on public or non-public paths, roads or other traffic surfaces. The wheels 62 are in particular pneumatic-tired, so that smaller obstacles can be easily over-come.

The cleaning vehicle 1 is equipped in particular with four wheels 62, which are arranged in pairs opposite each other in the axial direction of the vehicle transverse axis 11, analogous to the track wheels 14.

FIG. 3 shows only the wheels 62 assigned to one of the two long sides of the cleaning vehicle 1.

In accordance with the embodiment shown in FIG. 3, both the track wheels 14 and the wheels 62 are expediently arranged on the vehicle chassis 15.

An advantageous embodiment is one in which the track wheels 14 or the wheels 62 are adjustable relative to the vehicle chassis 15 in an axial direction of the vehicle high axis 12, which can be described as the height direction, in order to be able to set different height positions.

By way of example, the height adjustability refers to the wheels 62. These are attached to the vehicle chassis 15 in such a way that they can be rotated via swivel arms 63 and can be driven by means of an associated actuating device 64 to perform an adjustment movement 65 indicated by a double arrow, which is, for example, a pivoting movement. As part of the adjustment movement 65, each wheel 62 can be positioned either in a raised position relative to the track wheels 14, as illustrated by solid lines, or in a lowered position relative to the track wheels 14, as indicated by dotted lines.

The raised position of the wheels 62 means that the track wheels 14 are in a lowered, activated position relative to them, protruding downwards beyond the wheels 62, in which the cleaning vehicle 1 can take its position of use, as can be seen in FIG. 3. In contrast, the lowered position of the wheels 62, indicated by dotted lines, is accompanied by a relatively raised, deactivated position of the track wheels 14, in which the cleaning vehicle 1 can be moved without rails by means of the wheels 62, which are then ready for use.

In another embodiment, which is not illustrated, the wheels 62 always maintain a constant height position relative to the vehicle chassis 15, and the track wheels 14 are switched between the activated and deactivated positions by means of an adjustment movement between the track wheels 14 and the vehicle chassis 15.

Preferably, the cleaning vehicle 1 is equipped with an electronic control device 66, shown only schematically, which is designed to control the parts of the laser cleaning device 31a in particular during operation, wherein the electrical control lines provided for this purpose are not shown in the drawing for the sake of clarity. The electronic control device 66 is preferably performed as a part of the operating device 24.

For example, the electronic control device 66 also allows the controller of the adjustment movements 65 for the purpose of reconfiguring the cleaning vehicle 1 between a cleaning mode using the track wheels 14 and a standby mode using the wheel 62.

1. A cleaning vehicle for cleaning two rails of a track for rail vehicles, comprising:
a plurality of track wheels, via which the cleaning vehicle can be placed in a position of use on the two rails of a track, wherein the cleaning vehicle in its position of use can perform a vehicle movement on the two rails along the track, which can be induced by an associated drive device; and
a rail cleaning device which comprises a cleaning unit for each of the two rails of the track to be cleaned, which can be positioned or is positioned in the vicinity of the rail to be cleaned at least during a cleaning run of the cleaning vehicle that is performed by the vehicle movement, in order to perform a surface treatment on this rail during a cleaning process, which treatment induces the removal of contaminants, wherein
the rail cleaning device is designed as a laser cleaning device which has a laser located on board the cleaning vehicle, and wherein each cleaning unit comprises a laser radiation exit area for exit of laser radiation which can be generated by the laser and directed onto the rail to be cleaned in order to remove contaminants.

2. The cleaning vehicle according to claim 1, wherein two cleaning units, each assigned to one of two rails to be cleaned, are arranged at a distance from each other transversely to the direction of travel of the cleaning vehicle.

3. The cleaning vehicle according to claim 1, wherein the cleaning vehicle is equipped with a seat for operating personnel who are on board the cleaning vehicle during the vehicle movement.

4. The cleaning vehicle according to claim 1, wherein the laser belongs to laser class 4 with regard to the intensity of the laser radiation that can be generated by it, wherein each cleaning unit comprises a laser radiation shielding device, as a result of which the laser cleaning device as a whole is assigned to laser class 1.

5. The cleaning vehicle according to claim 1, wherein each cleaning unit comprises a laser radiation shielding device, which has a shielding housing that opaquely encloses a working chamber, in which the laser radiation exit area is located and which comprises a window facing or being able to face exclusively the rail to be cleaned during a cleaning process, through which the laser radiation exiting the working chamber at the laser radiation exit area can irradiate the associated rail.

6. The cleaning vehicle according to claim 1, wherein each laser radiation exit area of a laser optic is assigned to a radiation output head of the laser cleaning device.

7. The cleaning vehicle according to claim 6 wherein each cleaning unit comprises a laser radiation shielding device which has a shielding housing that opaquely encloses a working chamber, in which the laser radiation exit area is located and which comprises a window facing or being able to face exclusively the rail to be cleaned during a cleaning process, through which the laser radiation exiting the working chamber at the laser radiation exit area can irradiate the associated rail and each radiation output head is arranged inside the working chamber of the associated cleaning unit.

8. The cleaning vehicle according to claim 1, wherein each cleaning unit is assigned a positioning device by means of which the cleaning unit can be positioned at different height positions.

9. The cleaning vehicle according to claim 1, wherein the laser cleaning device is equipped with a suction device for removing ablation media produced during a cleaning process in the area of the cleaning units.

10. (canceled)

11. (canceled)

12. Cleaning The cleaning vehicle according to claim 1, wherein the drive device designed to induce the vehicle movement is an electric drive device.

13. The cleaning vehicle according to claim 1, wherein the drive device designed to induce the vehicle movement is a direct part of the cleaning vehicle.

14. The cleaning vehicle according to claim 1, wherein the cleaning vehicle is equipped with a power generator for generating the electrical energy required to operate the laser cleaning device.

15. (canceled)

16. The cleaning vehicle according to claim 1, wherein, in addition to the track wheels, the cleaning vehicle comprises a plurality of additional wheels which enable the cleaning vehicle to move without rails and without the involvement of the track wheels.

17. The cleaning vehicle according to claim 1, wherein the cleaning vehicle comprises a vehicle chassis on which the track wheels are arranged.

18. (canceled)

19. The cleaning vehicle according to claim 17, wherein in addition to the track wheels, the cleaning vehicle comprises a plurality of additional wheels which enable the cleaning vehicle to move without rails and without the involvement of the track wheels and both the track wheels and the additional wheels are arranged on the vehicle chassis, wherein the track wheels or the additional wheels are adjustable in a height direction relative to the vehicle chassis so that the track wheels can be selectively positioned to take the position of use in a lowered, activated position projecting downwards beyond the additional wheels or in a deactivated position raised relative to the additional wheels, enabling rail-independent vehicle movement by means of the additional wheels.

20. The cleaning vehicle according to claim 1, wherein the cleaning device comprises two vehicles that are coupled to each other in a manner that is both push- and pull-resistant and articulated, each vehicle comprising its own track wheels, where the two vehicles comprise a main vehicle and an auxiliary vehicle, wherein the main vehicle comprises the cleaning units and the auxiliary vehicle comprises the laser, wherein flexible optical connecting lines form an optical connection between the laser and the cleaning units for transmitting the generated laser radiation.

21. The cleaning vehicle according to claim 20, wherein the drive device designed to induce the vehicle movement is a direct part of the cleaning vehicle and the main vehicle comprises the drive device.

22. The cleaning vehicle according to claim 20, further comprising a suction device, wherein the suction device comprises at least one suction opening in the area of each cleaning unit which communicates with a suction power unit of the suction device and the main vehicle comprises the suction openings and the auxiliary vehicle comprises the suction power unit, wherein at least one flexible suction pipe forms a flow connection between the suction power unit and the suction openings that enables a suction flow.

23. The cleaning vehicle according to claim 20, wherein the cleaning vehicle is equipped with a power generator for generating the electrical energy required to operate the laser cleaning device and the power generator is located on board the auxiliary vehicle.

24. The cleaning vehicle according to claim 1, wherein the cleaning vehicle consists of a single vehicle which comprises all the components required for the operation of the laser cleaning device.

25. (canceled)
